(19) United States
(12) Patent Application Publication
(10) Pub. No.: US 2025/0021936 A1
(43) Pub. Date: Jan. 16, 2025

(54) SYSTEM AND METHOD FOR ONBOARDING A MERCHANT ON A COMPUTING PLATFORM

(71) Applicant: iCreditWorks, Iselin, NJ (US)

(72) Inventors: Shankar R Iyer, East Windsor, NJ (US); Suresh G Nair, Robbinsville Twp, NJ (US); Stephen E Sweeney, Mahwah, NJ (US)

(21) Appl. No.: 18/467,761

(22) Filed: Sep. 15, 2023

Related U.S. Application Data
(60) Provisional application No. 63/513,392, filed on Jul. 13, 2023.

(51) Int. Cl. G06Q 10/10

(52) U.S. Cl. CPC G06Q 10/10

(57) ABSTRACT

A system and method for onboarding a merchant on a computing platform is disclosed. The system receives a merchant onboarding request containing personal, business, and insurance information. Using a trained artificial intelligence risk model, the system generates an identifier verification score and a business risk score for the request. The system then verifies the merchant's information based on these scores and provides access to a real-time merchant portal based on the verification results and the type of merchant. The system collects various details about the merchant, such as business name, type, address, contact information, EIN, business license, NPI number (if applicable), insurance information, years in business, number of employees, and annual sales volume. This system streamlines and automates the onboarding process, ensuring efficient and secure merchant activation.

### CROSS-REFERENCE TO RELATED APPLICATION(S)

This application claims the priority to incorporate by reference the entire disclosure of U.S. provisional patent application No. 63/513,392, filed on Jul. 13, 2023, titled “System and method for self-onboarding of vendor based on risk-assessment”.

### TECHNICAL FIELD

Embodiments of the present disclosure relate to merchant onboarding systems, and more particularly relates to a system and a method for onboarding a merchant on a computing platform.

### BACKGROUND

Generally, merchants offer items (i.e., goods, services, products, and the like) for acquisition (i.e., sale, rent, lease, and the like) by customers. To understand items offered by the merchant for acquisition, the merchant may maintain an inventory of the items. In some examples, the merchant may accomplish offerings through a computerized system that tracks inventory and provides point-of-sale functionality. The inventory may indicate a quantity of a particular good the merchant has available. Additionally, and/or alternatively, the inventory may indicate a type of a particular service/product offered by the merchant. In some examples, the inventory may be dependent on service/product providers that are employed by, or otherwise acting on behalf of, the merchant. Current techniques for onboarding service providers require a merchant to manually enter information about individual service/product providers.

Further, some of service/product providers may interface with customers via network-based platforms, such as internet websites, mobile applications, and/or the like. Initial user registration is an important process that requires secure verification of users to avoid risks associated with fraudulent use of service/product provider resources. In addition, service/product providers may engage in customer onboarding, which is the process of introducing customers to new products or services. However, there may be challenges associated with manual onboarding of service/product partner/provider. While some partial automation exists, none of the existing solutions offer a fully automated process that assesses risk during the onboarding phase. The manual onboarding processes are time-consuming and resource-intensive for onboarding platforms. Lack of automation in evaluating risk during the onboarding phase can lead to inefficiencies and potential risks for the onboarding platforms. There may be limited access to comprehensive and reliable data for risk assessment. Further, there may be need for extensive involvement from commercial or development teams, streamlining the onboarding process. Conventional methods may have an inability to streamline the onboarding process while maintaining a superior customer experience.

Consequently, there is a need for an improved system and method for self-onboarding of vendor based on risk-assessment, to address at least the aforementioned issues in the prior art.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a computer-implemented system for onboarding a merchant on a computing platform. The system receives a request for onboarding a merchant from a user. The request includes personal information, business information and business insurance information associated with the merchant. Further, the system generates an identifier verification score and a business risk score for the received request based on a trained artificial intelligence risk model. Furthermore, the system verifies the personal information, business information and business insurance information associated with the merchant based on the generated identifier verification score and the business risk score. Additionally, the system provides access to a real-time merchant portal based on results of verification and type of the merchant.

Another aspect of the present disclosure provides a computer-implemented method for onboarding a merchant on a computing platform. The method includes receiving a request for onboarding a merchant from a user. The request includes personal information, business information and business insurance information associated with the merchant. Further, the method includes generating an identifier verification score and a business risk score for the received request based on a trained artificial intelligence risk model. Furthermore, the method includes verifying the personal information, business information and business insurance information associated with the merchant based on the generated identifier verification score and the business risk score. Additionally, the method includes providing access to a real-time merchant portal based on results of verification and type of the merchant.

A non-transitory computer-readable storage medium having instructions stored therein that, when executed by one or more hardware processors, cause the one or more hardware processors to perform method steps. The one or more hardware processors receive a request for onboarding a merchant from a user, wherein the request comprises personal information, business information and business insurance information associated with the merchant. Further, the one or more hardware processors generate an identifier verification score and a business risk score for the received request based on a trained artificial intelligence risk model. Furthermore, the one or more hardware processors verifies the personal information, business information and business insurance information associated with the merchant based on the generated identifier verification score and the business risk score. Additionally, the one or more hardware processors provides access to a real-time merchant portal based on results of verification and type of the merchant.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1 illustrates an exemplary block diagram representation of a network architecture implementing a system for onboarding a merchant on a computing platform, in accordance with an embodiment of the present disclosure;

FIG. 2 illustrates an exemplary block diagram representation of a computer-implemented system, such as those shown in FIG. 1, capable of onboarding a merchant on a computing platform, in accordance with an embodiment of the present disclosure;

FIG. 3 illustrates an exemplary process flow diagram representation of a method for self-onboarding of vendor based on risk-assessment, in accordance with an embodiment of the present disclosure;

FIG. 4A illustrates an exemplary block diagram representation of method of independent office activation for physician assistant (PA), in accordance with an embodiment of the present disclosure;

FIG. 4B illustrates an exemplary block diagram representation of method of an independent office activation for provider relation officer (Pro), in accordance with an embodiment of the present disclosure;

FIG. 5 illustrates a flow chart depicting a method of onboarding a merchant on a computing platform, in accordance with the embodiment of the present disclosure; and

FIG. 6 illustrates an exemplary block diagram representation of a hardware platform for implementation of the disclosed system, according to an example embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Embodiments of the present disclosure provide a system and a method for onboarding a merchant on a computing platform. The present disclosure provides a self-onboarding process for vendors based on risk assessment. The system streamlines the provider onboarding process, saving time for team members by minimizing manual tasks and simplifying activation procedures. As a result, team members can focus on more critical aspects of their work, improving overall efficiency. Additionally, the present ensures a seamless and user-friendly experience for providers, as they can easily access a portal, complete necessary steps, and activate their accounts independently, leading to a smoother onboarding process. Moreover, the present disclosure reduces reliance on commercial and development teams. Providers with fewer than e.g., 10 locations can initiate the account activation process autonomously, without needing assistance from these teams. This not only reduces the workload on commercial and development teams but also empowers providers to proceed at their own pace. Furthermore, the system enhances data validation by utilizing external databases and capturing social media data. This validation process ensures the accuracy and authenticity of the information provided by providers during onboarding.

Additionally, email verification prompts are sent to providers, verifying the validity and activity of their email addresses, thereby maintaining the security and integrity of the onboarding process. Within the automated flow, providers can enter and manage their practice details, including addresses, tax numbers, practice names, and business names. They also have the ability to assign practice administrators (PAs) and view practice profiles, streamlining practice management and organization. The system performs thorough validation checks for each practice entered by providers, ensuring that all necessary information is accurately provided, reducing the chances of errors or incomplete data. The flow also includes verification of financial details and authorization for entering financial information, promoting compliance with regulatory requirements and mitigating potential risks. Additionally, the system offers training modules tailored to the specific needs of providers. Providers can choose to complete the compulsory training or skip it if they are already familiar with the platform, providing flexibility during onboarding. By automating the provider onboarding process, the system can handle a larger volume of activations while maintaining a high level of accuracy and customer satisfaction.

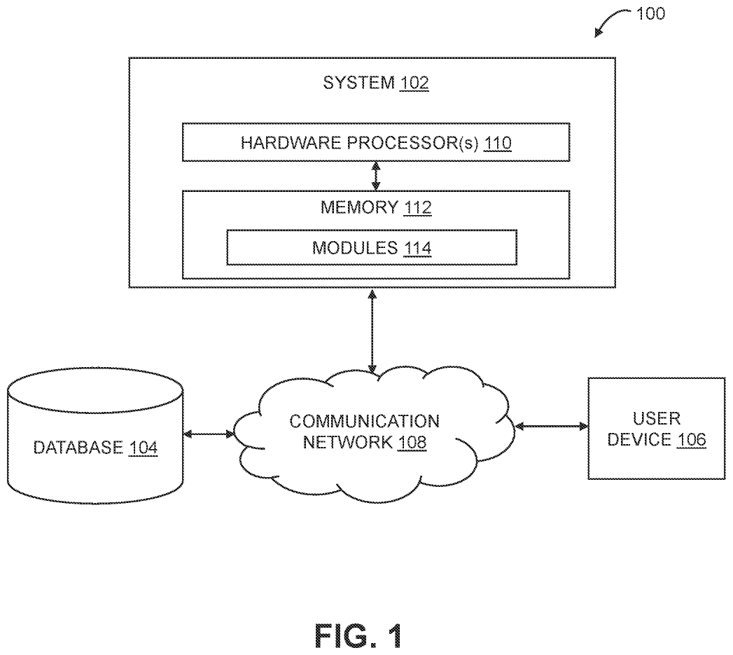

Referring now to the drawings, and more particularly to FIG. 1 through FIG. 6, where similar reference characters denote corresponding features consistently throughout the figures, there are shown preferred embodiments and these embodiments are described in the context of the following exemplary system and/or method.

FIG. 1 illustrates an exemplary block diagram representation of a network architecture 100 implementing a system 102 for onboarding a merchant on a computing platform, in accordance with an embodiment of the present disclosure. According to FIG. 1, the network architecture 100 includes one or more electronic devices 102 associated with one or more users communicatively coupled to a system 102 via a communication network 106. In an exemplary embodiment of the present disclosure, the one or more electronic devices 102 may include a laptop computer, desktop computer, tablet computer, smartphone, wearable device, a digital camera, and the like. Further, the communication network 106 may be the internet or any other wireless network 106. The system 102 may be hosted on a central server, such as cloud server or a remote server. According to FIG. 1, the network architecture 100 may include the system 102, a database 104, and a user device 106. The system 102 may be communicatively coupled to the database 104, and the user device 106 via a communication network 108. The communication network 108 may be a wired communication network and/or a wireless communication network. The database 104 may include, but is not limited to, personal information, business information and business insurance information, merchant information, legal business name, doing business as (DBA), business type, majority owner's name, business address, business phone, business cell, business email address, website, employer Identification number (EIN) number, business license, national provider identifier (NPI) number, business liability insurance information, years in business, number of employees, principals and executives, annual sales volume information, social media information, financial partner information, services offered information, any other data, and combinations thereof. The database 104 may be any kind of database such as, but are not limited to, relational databases, dedicated databases, dynamic databases, monetized databases, scalable databases, cloud databases, distributed databases, any other databases, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for a merchant onboarding need. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for onboarding a merchant on a computing platform. Execution of the machine-readable program instructions by the hardware processor 110 may enable the proposed system 102 to onboard a merchant on a computing platform. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at different locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may receive a request for onboarding a merchant from a user. The request includes personal information, business information and business insurance information associated with the merchant. The business insurance information includes an insurance declaration page and a contract used to document a project. In an exemplary embodiment, to receive the request for onboarding the merchant from the user, the system 102 may receive personal information associated with the merchant from the user device 106. In an exemplary embodiment, the system 102 may authenticate the received personal information associated with the merchant based on corresponding information stored in one or more external sources. In an exemplary embodiment, the system 102 may authenticate the user device based on device identifier.

In an exemplary embodiment, the system 102 may generate an identifier verification score and a business risk score for the received request based on a trained artificial intelligence risk model.

In an exemplary embodiment, the system 102 may verify the personal information, business information and business insurance information associated with the merchant based on the generated identifier verification score and the business risk score.

In an exemplary embodiment, the system 102 may provide access to a real-time merchant portal based on results of verification and type of the merchant.

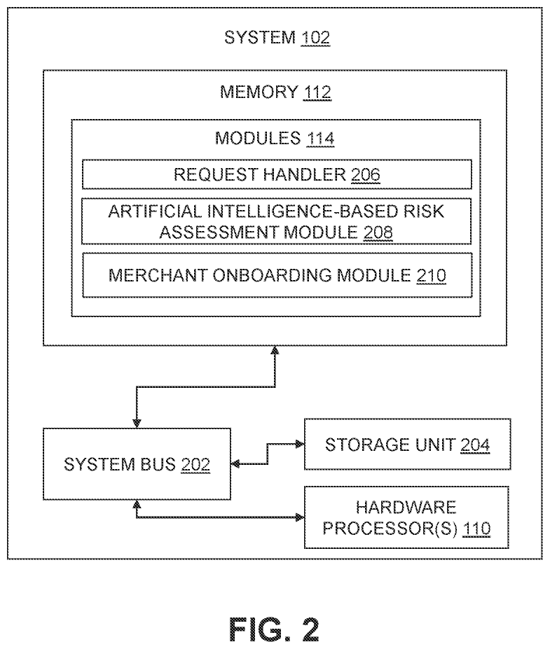

FIG. 2 illustrates an exemplary block diagram representation of a computer-implemented system 102, such as those shown in FIG. 1, capable of onboarding a merchant on a computing platform, in accordance with an embodiment of the present disclosure. The system 102 may also function as a computer-implemented system (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

Further, the plurality of modules 114 includes a request handler 206, an artificial intelligence-based risk assessment module 208, and a merchant onboarding module 210.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a database such as those shown in FIG. 1. The storage unit 204 may store, but is not limited to, personal information, business information and business insurance information, merchant information, legal business name, doing business as (DBA), business type, majority owner's name, business address, business phone, business cell, business email address, website, employer Identification number (EIN) number, business license, national provider identifier (NPI) number, business liability insurance information, years in business, number of employees, principals and executives, annual sales volume information, social media information, financial partner information, services offered information, any other data, and combinations thereof. The storage unit 204 may be any kind of database such as, but are not limited to, relational databases, dedicated databases, dynamic databases, monetized databases, scalable databases, cloud databases, distributed databases, any other databases, and a combination thereof.

In an exemplary embodiment, the request handler 206 may receive a request for onboarding a merchant from a user. The request includes personal information, business information and business insurance information associated with the merchant. The business insurance information includes, but not limited to, an insurance declaration page and a contract used to document a project. In an exemplary embodiment, to receive the request for onboarding the merchant from the user, the request handler 206 may receive personal information associated with the merchant from the device 106. Further, the request handler 206 may authenticate the received personal information associated with the merchant based on corresponding information stored in one or more external sources. Furthermore, the request handler 206 may authenticate the user device based on device identifier. In an exemplary embodiment, to receive the request for onboarding the merchant from the user, the request handler 206 may obtain business information and business insurance information associated with the merchant from the user device 106. The business information and business insurance information includes, but is not limited to, legal business name, doing business as (DBA), business type, majority owner's name, business address, business phone, business cell, business email address, website, employer Identification number (EIN) number, business license, national provider identifier (NPI) number, business liability insurance information, years in business, number of employees, principals and executives, and annual sales volume.

In an exemplary embodiment, the artificial intelligence-based risk assessment module 208 may generate an identifier verification score and a business risk score for the received request based on a trained artificial intelligence risk model. Further, the artificial intelligence-based risk assessment module 208 may verify the personal information, business information and business insurance information associated with the merchant based on the generated identifier verification score and the business risk score. In an exemplary embodiment, the merchant onboarding module 210 may provide access to a real-time merchant portal based on results of verification and type of the merchant. In an exemplary embodiment, to provide access to the real-time merchant portal based on results of verification and type of the merchant, the merchant onboarding module 210 may identify type of merchant based on the results of verification. The merchant onboarding module 210 may retrieve one or more access privileges based on the identified type of merchant. Further, the merchant onboarding module 210 may provide access to the real-time merchant portal based on the retrieved one or more access privileges.

In an exemplary embodiment, to generate the identifier verification score and the business risk score for the received request based on the trained artificial intelligence risk model, the artificial intelligence-based risk assessment module 208 may obtain credit information associated with the merchant. Further, the artificial intelligence-based risk assessment module 208 may verify the obtained credit information associated with the merchant. Furthermore, the artificial intelligence-based risk assessment module 208 may generate the business risk score for the received request based on the verified credit information.

In an exemplary embodiment, to generate the identifier verification score and the business risk score for the received request based on the trained artificial intelligence risk model, the artificial intelligence-based risk assessment module 208 may extract a set of parameters from the personal information, business information and business insurance information associated with the merchant. Further, the artificial intelligence-based risk assessment module 208 may classify the extracted set of parameters into one or more categories based on type of information. Furthermore, the artificial intelligence-based risk assessment module 208 may apply the classified set of parameters to the trained artificial intelligence risk model. Additionally, the artificial intelligence-based risk assessment module 208 may generate the identifier verification score and the business risk score for the received request based on results of the trained artificial intelligence risk model.

In an exemplary embodiment, to generate the identifier verification score and the business risk score for the received request based on the trained artificial intelligence risk model, the artificial intelligence-based risk assessment module 208 may obtain social media information, financial partner information, and services offered information associated with the merchant. Further, the artificial intelligence-based risk assessment module 208 may generate a social media score, business quality score for the merchant based on the obtained social media information, financial partner information, and services offered information. Furthermore, the artificial intelligence-based risk assessment module 208 may generate the business risk score based on the generated social media score, and the business quality score.

In an exemplary embodiment, to verify the personal information, business information and business insurance information associated with the merchant based on the generated identifier verification score and the business risk score, the artificial intelligence-based risk assessment module 208 may obtain a valid government photo ID and biometric data of the merchant from the user device 106. The artificial intelligence-based risk assessment module 208 may perform a biometric verification and user identity verification of the merchant using the obtained valid government photo ID and the biometric data. Furthermore, the artificial intelligence-based risk assessment module 208 may determine fraud and risk associated with the merchant based on the biometric verification and the user identity verification. Additionally, the artificial intelligence-based risk assessment module 208 may verify the personal information associated with the merchant based on the determined fraud and risk associated with the merchant.

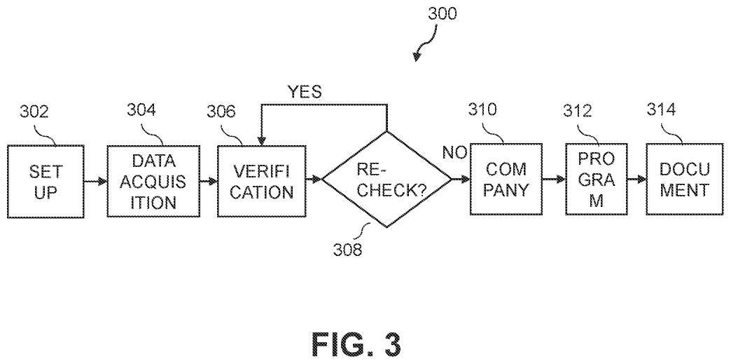

FIG. 3 is a process flow diagram illustrating a method 300 for self-onboarding of vendor based on risk-assessment, in accordance with an embodiment of the present disclosure.

At step 302, the method includes setting up, by the one or more hardware processors 110, up merchant account and provides key information needed to acquire information from external databases. For example, the qualification process may be enabled through the website and the mobile application. The system 102 provides the ability to identify the industry/vertical of the merchant, provides the ability to bulk upload merchant information, provides the ability to bulk exclude data. provides tracking that identifies, determines changes to the merchant qualification data, the date and time of the changes, provides the ability to utilize the external databases to provide an ID verification score and a risk score. The scores (ID verification and risk scores) may categorize the merchant as green (passes without issues to review), amber (did not fail but a manual review should be performed to view flags triggered, red (contractor failed the review). The system 102 may capture and store data from the merchant's electronic data file from an external database. Additional information that is placed in the merchant's file may include SIC code(s) and SIC descriptions, businesses with the same address, businesses with the same phone number, businesses with the same people, corporate filings, active registered trade name, active fictitious names, attach a PDF of the data from external database in the merchant's electronic file. The system 102 may capture and store social media information about merchants from internet sites. This information may be converted into a social media score and used to qualify the merchant.

For the user to get started they should be presented with a screen to create a username and password. The username should be their email address. Should leverage existing Platform capabilities. Provide the ability to launch the merchant qualification process from the website for invited merchants initially. Require merchants to enter legal name of the business, the BDA or assumed business name, the physical address of the business, main phone number for the business, a federal tax identification number (FEIN), name of the dentist that owns the dental practice, the NPI number of the dentist that owns the dental practice, the name and title of the person completing the application, the contact information for the person completing the application, and the like.

At step 304, the method includes acquiring, by the one or more hardware processors 110, data. During the data acquisition stage, the baseline demographic information provided by the merchant will be used to pull additional data from the external database. The data acquired and presented to the merchant for validation may include legal business name, doing business as (DBA), business type (e.g., limited liability company (LLC), limited liability partnership (LLP), small-business corporation (S-Corp), sole proprietorship), majority owner's name, business address, business phone, business cell, business email address, website, EIN number, business license, NPI number e.g., dental, business liability insurance information, years in business, number of employees, principals and executives, annual sales volume, and the like.

At step 306, the method includes verifying, by the one or more hardware processors 110, the acquired data. During verification stage the data pulled may be presented to the merchant for validation. Information may need to be presented to the borrower. Provide the ability for the borrower to edit the information presented.

At step 308, the method includes re-checking, by the one or more hardware processors 110, the verified data for any material changes to the data provided by the external database may require additional verification. For example, additional verification may require the name of business, address, owner of business, and the like. Initially when the merchant changes data, there may be changes manually reviewed to understand the magnitude of the change.

At step 310, the method includes receiving, by the one or more hardware processors 110, company details. During the company stage, the merchant is providing information about their company. The information may help in qualifying the type of contractor, average size of transaction. Some types of contractors may be riskier than others. The types of services offered, and percentage of projects may include home improvement choices, kitchen, bathroom, flooring, heating-ventilation-air-conditioning (HVAC), roofing, additions, decks and patio, windows, doors, and siding, patient details related to dental, other. Provide the ability for the user to assign a percentage to each of the choices. The geographic area where work is performed includes states and cities. For home improvement, quotes turn into projects. The system 102 may obtain application based on quotes and fundings based on projects.

At step 312, the method includes capturing, by the one or more hardware processors 110, data elements within the program stage. This is information that the merchant needs to provide. The data may include reference data, existing financing data, existing financing partners, application approval rate, application funding rate.

Further, for security of the system 102, all merchants may go through the biometrics process. The security section requires the merchant to provide official forms of ID and biometric information to validate their identity. The system 102 provides the ability for the user to scan a valid government photo ID, leveraging existing platform capabilities. The system 102 allows biometric verification leveraging existing Platform capabilities and provides the ability to compare and validate ID and biometric information fraud validation, risk assessment. Further, the system displays a processing message to the user while the validation is being performed.

At step 314, the method includes verifying, by the one or more hardware processors 110, the user. The system 102 display a provider portal agreement and allow the user to sign the agreement using current platform e-signature capabilities. The system 102 provides the ability to scroll through the document allowing the user to read the entire agreement. The system 102 provides the ability to email the signed agreement to the user and send it to the user's inbox. Furthermore, the system 102 provides a congratulations screen to communicate the completion of the validation and allow the user to go home to the merchant portal.

The system 102 may provide the ability to route merchant applications falling into the red or amber category to a work queue for an employee to review. The system ensures applications are routed to a system that provides visibility to more than one user and has reporting capabilities, improving the ability to manage the queue of work. All data entered by the merchant and captured via the external database and social media should be visible. The system 102 may provide the ability for the designated employee(s) to make changes to the data for the prospective merchant. This adds information/data in an ICW comments or list section. The system 102 provides the ability for the employee(s) to be able to document notes on the merchant profile, refer the merchant to sign in and complete the qualification process (i.e., sign the provider agreement), send a notice that additional information is needed, send a notice that the merchant has been declined. Further, the system 102 may generate a report. The report includes the onboarding process, new merchant on-boarding by vertical of date, name, address, business type, volume, sales, outcome (approved, under review, declined), and the like.

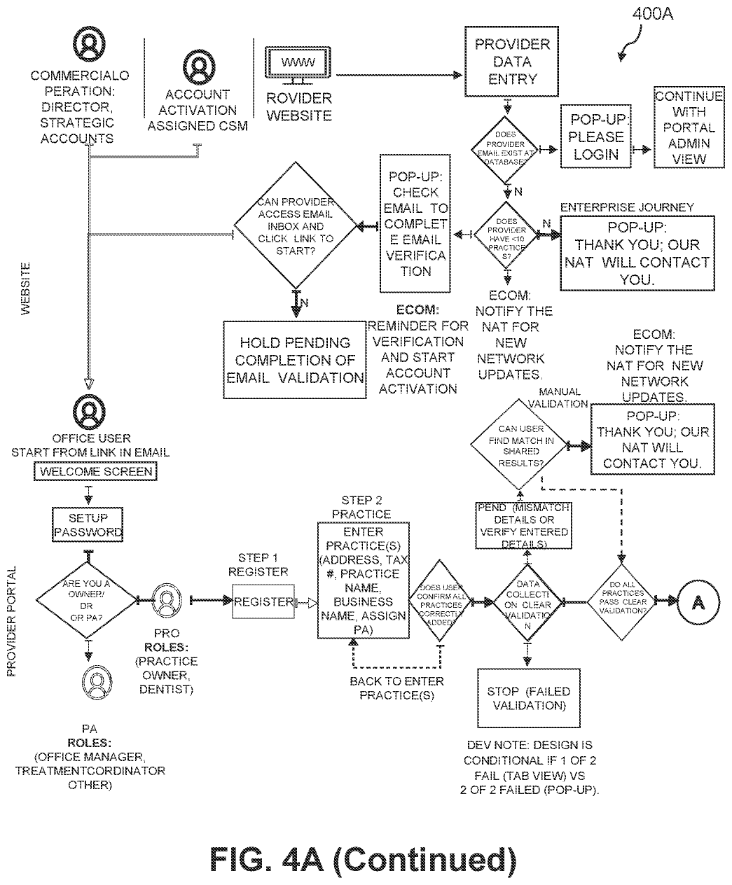

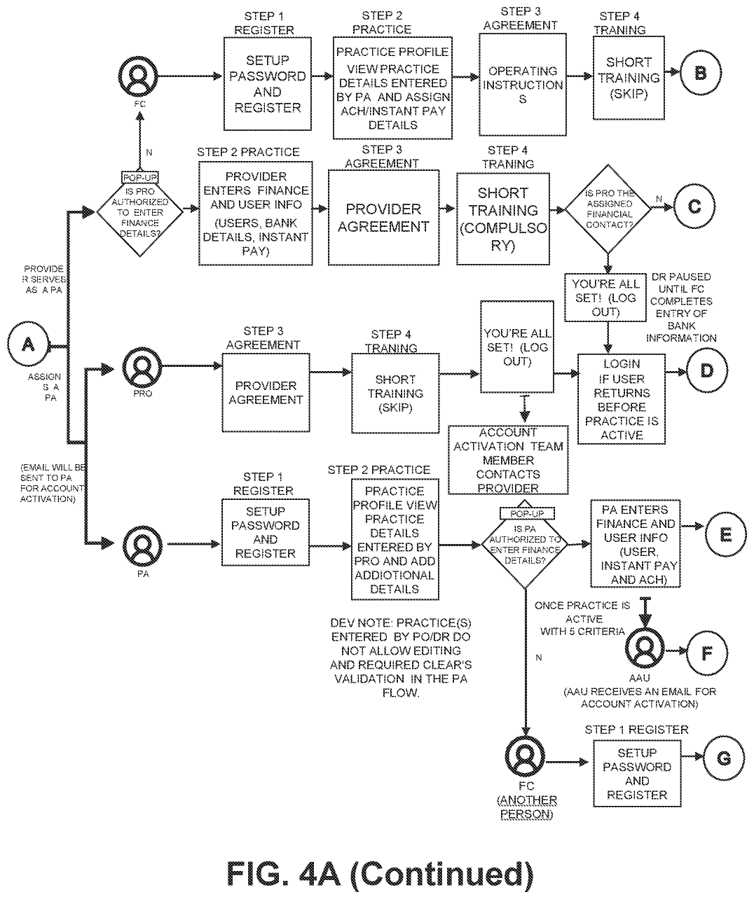

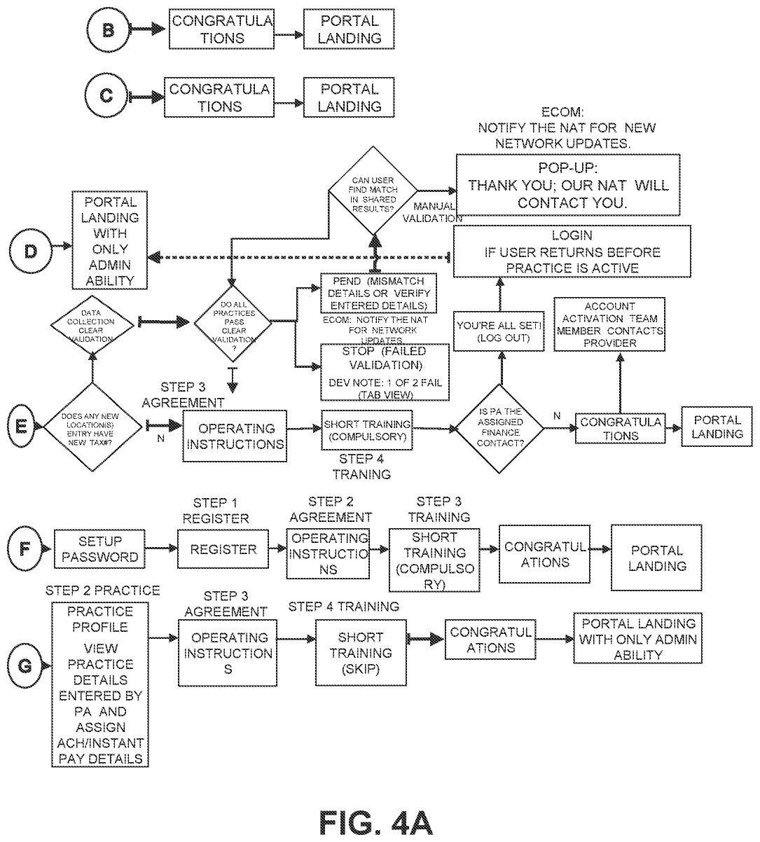

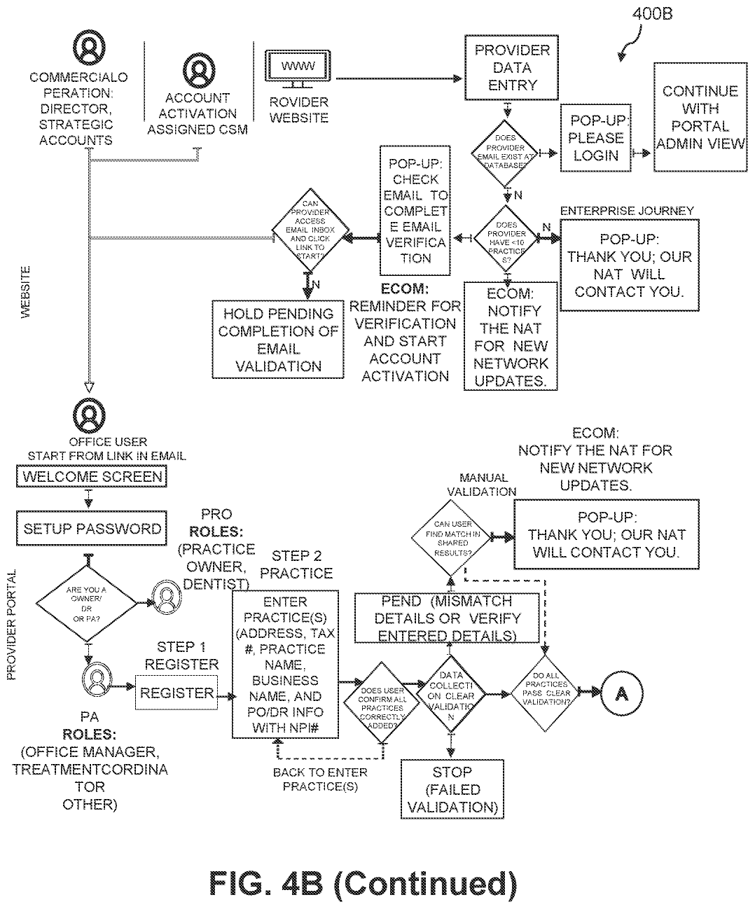

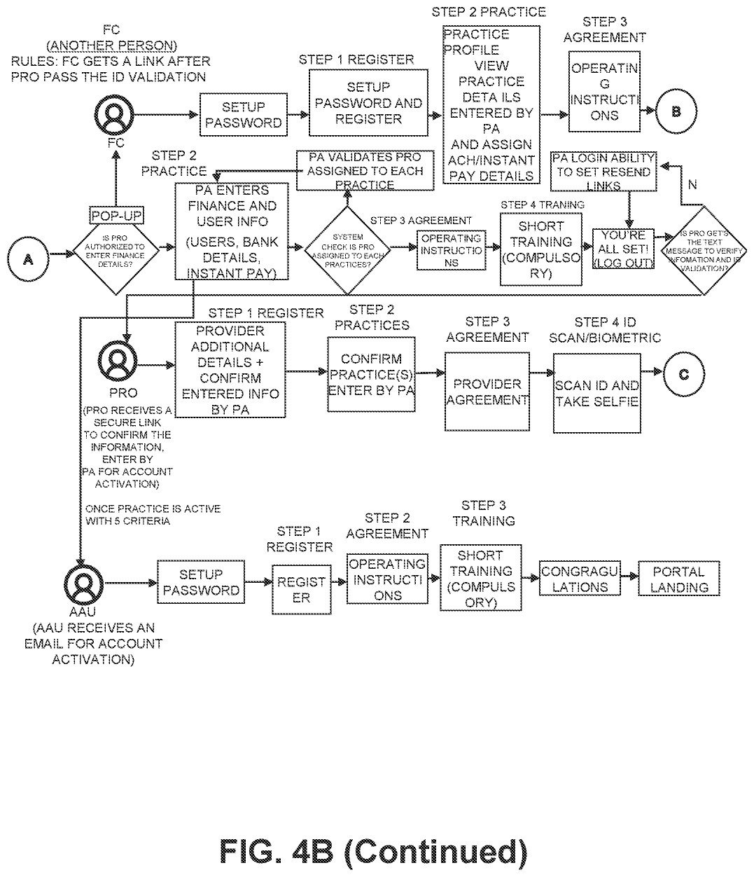

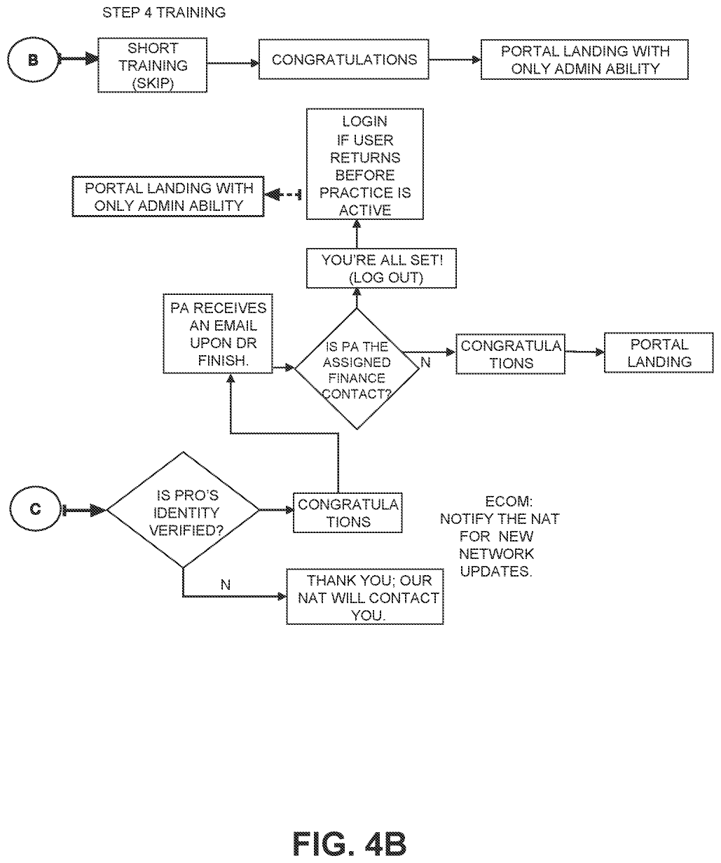

FIG. 4A illustrates an exemplary block diagram representation of method 400A of independent office activation for physician assistant (PA), in accordance with an embodiment of the present disclosure. FIG. 4A represents an end-to-end flow of various scenarios of risk-based onboarding. A provider office can have multiple roles such as for example, a dentist, an office manager, a financial contact, and the like. Depending on who starts the process, the process flow may be different. FIG. 4A depicts the flow details from start to finish. For example, in case a provider office needs to be activated, the system 102 may determine passing risk score, bank information, agreement signed by responsible owner, and the like. A complete training agreement needs to be signed by the practice owner. Identity (ID) and bio-metric validation may be performed for the owner only.

In an embodiment of the present disclosure, the system 102 is configured to perform automated independent office activation flow for a service/product provider. Further, the system 102 is configured to capture provider data in the commercial operations department, specifically the director of strategic accounts. In an embodiment of the present disclosure, the system 102 is configured to assign the account activation to a customer success manager (CSM) (not shown). The provider is directed to the provider website and prompted to check if an email exists on a database. If the email is confirmed, the provider is allowed to proceed to the provider portal. If not, the provider may be asked to verify the email through a pop-up message.

In an embodiment of the present disclosure, the system 102 is configured to request the provider, if the provider can access the email inbox and click the link provided to start the activation process. Additionally, the system 102 checks if the provider has fewer than 10 practices. If the response is no, the system 102 may pop up a message to inform that a network access team (NAT) will contact the provider. However, if the provider meets the criteria, the email validation is put on hold until completion. Further, an electronic communication (e-com) system (not shown) notifies the NAT of new network updates and sends a reminder for verification and account activation. The flow then progresses to the initial step, where the office user starts the registration process by clicking a link in the email and setting up a password. A welcome message is displayed, followed by a check to determine if the user can find a match in shared results.

The user sets up a password, the system 102 may request provider/vendor details. The provider/vendor may be, but not limited to, an owner, a doctor, physician assistant (PA), office manager, treatment coordinator, a service provider, a product provider, a vendor, and the like. The PA performs manual validation to verify the assigned provider relations officer (PRO) for each practice. The user enters practice details, including address, tax number, practice name, business name, and purchase order/designated representative (PO/DR) information with national provider identifier (NPI) number. After entering the practice(s), the user confirms if all the practices have been correctly added.

In an embodiment of the present disclosure, the system 102 is configured to perform data collection and clear validation to ensure that all practices pass the validation process. The PA is authorized to enter finance details. Further, the PA enters finance and user information, including users, bank details, and instant pay options. If the user returns before the practice is active, they can log in using the PA login.

In an embodiment of the present disclosure, the system 102 is configured to check if the PRO is assigned to each practice. Once the checks are complete, the user is all set and can log out. If the user needs to access, the user may have portal landing with only admin abilities and the ability to resend links. Further, a message of congratulations is displayed, and the NAT will contact the user. Various roles, such as practice owner, dentist, office manager, treatment coordinator, and others, are assigned. The PA can view the practice details entered and assign automated clearing house (ACH) and instant pay details.

In an embodiment of the present disclosure, the system 102 is configured to train, with specific rules for Finance Contact (FC) receiving a link after the PRO passes ID validation. If there are mismatches or the entered details need verification, the process is put on hold. In an embodiment of the present disclosure, the system 102 is configured to check pro Start flow, and the practice profile is reviewed. Another person, such as the pro or PA, can set up a password and register. Operating instructions are provided, and short training may be required.

If the pro receives a text message to verify information and undergo ID validation, the process continues. The PA receives an email upon the doctor finishing the process. It is checked if the PA is the assigned finance contact and if the pro's identity has been verified. If everything is successful, congratulations are given. If not, the user is directed back to enter practice(s), and if validation fails, the process is stopped.

In an embodiment of the present disclosure, the system 102 is configured to request provider additional details are and confirmed by the PA. The system 102 confirms the practices entered into by the PA. In an embodiment of the present disclosure, the system 102 is configured to agree to the provider agreement and performs ID scanning and recording picture for biometric verification. The e-com system notifies the NAT of new network updates. Finally, the PRO receives a secure link to confirm the information entered by the PA for account activation. Once the practice is active and meets the specified criteria, the initial step is performed. The account activation user (AAU) receives an email for account activation. The process continues with agreement, training, and ultimately, congratulations are given upon successful completion, leading to the portal landing.

In another embodiment, the system 102 is configured to receive data from the provider, facilitated by commercial operations team, specifically the director of strategic accounts. Once the data is entered, the system 102 assigns the account activation to a customer success manager (CSM). The provider is directed to the website and asked if their email exists in the database. If it does, they proceed to the provider portal, where they can log in and continue with the administrative view. If the email does not exist, a pop-up message prompts the provider to check their email for completion of email verification. The providers are asked to access their email inbox and click on the link provided to initiate the verification process. Additionally, the system 104 checks if the provider has less than 10 practices. If they do not meet this criterion, a pop-up message informs them that the NAT may contact them. In case the email validation is pending, the account is put on hold until the verification is completed. The e-com team is notified to inform the NAT about any new network updates, and reminders are sent to the provider for verification and starting the account activation.

The registration process proceeds with the provider setting up a password and registering as an office user. The provider may start from the link provided in the email and proceed to enter their practice details. The system 104 may allow them to register their practice(s) by providing address, tax number, practice name, business name, and assigning a practice administrator (PA) with an NPI number. The user is prompted to confirm if all practice details have been correctly added. The system collects and validates the data, performing clear validation checks for each practice. If all practices pass the clear validation, the provider proceeds to the next step. If there is a mismatch or any details require verification, the process is put on hold. At this stage, the provider enters their finance and user information, including bank details and instant pay options. The system 104 checks if the assigned PA is authorized to enter the finance details. If authorized, the process moves forward. Otherwise, it is put on hold.

Further, the provider is authorized and guided through the agreement step. The system 104 provides a provider agreement and is provided with operating instructions. If the provider is a practice owner or dentist, they are assigned specific roles. The PA views the practice details entered by the provider and assigns ACH/Instant Pay details. The system 104 then moves on to training, where a short training session is provided. If the provider skips the training, they proceed to the next step. If compulsory, the provider completes the training. At this point, the system checks if the PA is the assigned financial contact. If not, the process is halted. Once all the steps are successfully completed, the provider receives a confirmation message that they are all set and can log out of the system. The portal landing page provides access with only administrative abilities.

In cases where the user returns before the practice is active, the provider can log in using their credentials. The portal landing page allows access with only administrative abilities. The system verifies if there is a match in the shared results. If there is no match, the process moves to manual validation, and the NAT is notified of any network updates. If the provider serves as the PA, they assign a PA to the practice. Roles are assigned, including office manager, treatment coordinator, or other roles as needed. If the user finds a match in the shared results, they proceed to data collection and clear validation. If all practices pass the clear validation, the process continues. If there is a failed validation, the process is stopped. The system 104 guides the user through the remaining steps of registration, agreement, and training as previously described.

Various embodiments of the present disclosure provide a self-onboarding of vendor based on risk-assessment. The present disclosure automates the provider onboarding process freeing up time for team members by reducing manual tasks and streamlining the activation flow. This allows them to focus on other critical aspects of their work, improving overall efficiency. Further, the present disclosure ensures a seamless and user-friendly experience for providers. They can easily access a portal, complete necessary steps, and activate their accounts independently, resulting in a smoother onboarding process. Furthermore, the present disclosure reduces dependency on commercial/development teams. Providers with fewer than 10 locations can initiate the account activation process independently without relying on the commercial or development teams. This reduces the workload on these teams and enables providers to proceed at their own pace.

Further, the present disclosure enhances data validation, by utilizing external databases, and captured social media data. The system can validate and supply accurate data during the onboarding process. This helps in ensuring the authenticity and reliability of the information provided by providers. Furthermore, the system prompts email verification to the providers to check their email for verification, ensuring that their email address is valid and active. This helps in maintaining the security and integrity of the onboarding process. The automated flow allows providers to enter and manage their practice details, including addresses, tax numbers, practice names, and business names. They can also assign practice administrators (PAs) and view practice profiles, enabling better organization and streamline practice management. The system performs clear validation checks for each practice entered by providers. This ensures that all necessary information is accurately provided, reducing the chances of errors or incomplete data. The automated flow includes the verification of finance details and authorization for entering financial information. This helps in ensuring compliance with regulatory requirements and mitigating potential risks.

Furthermore, the system offers training modules that can be tailored to the specific needs of providers. Providers can choose to complete the compulsory training or skip it if they are already familiar with the platform, providing flexibility in the onboarding process. By automating the provider onboarding process, the system can handle a larger volume of activations while maintaining a high level of accuracy and customer satisfaction. This scalability contributes to the growth and success of the program.

FIG. 4B illustrates an exemplary block diagram representation of method 400B of an independent office activation for provider relation officer (Pro), in accordance with an embodiment of the present disclosure. FIG. 4B represents an end-to-end flow of various scenarios of risk-based onboarding. A provider office may have multiple roles such as, for example, a dentist, an office manager, a financial contact, and the like. Depending on who starts the process, the flow may be different. FIG. 4B depicts the flow details from start to finish. For the provider office to be activated, the system 102 may determine, passing risk score, bank information, agreement signed by responsible owner, and the like. A complete training agreement needs to be signed by the practice owner. ID and bio-metric validation performed for the owner only. For example, if there are more than 10 practice locations, they get a white glove service from a commercial operations team. The top portion of FIG. 4B illustrates the white glove service.

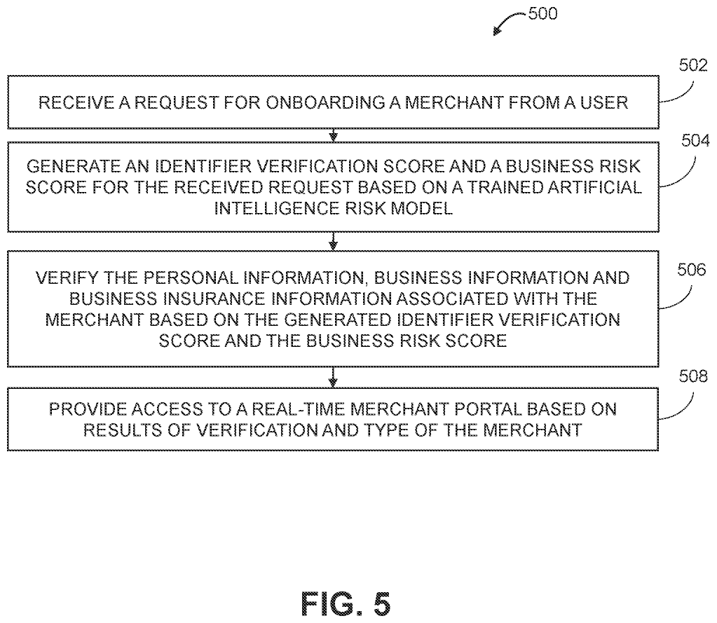

FIG. 5 illustrates a flow chart depicting a method 500 of onboarding a merchant on a computing platform, in accordance with the embodiment of the present disclosure.

At block 502, the method 500 may include receiving, by one or more hardware processors 110, a request for onboarding a merchant from a user. The request comprises personal information, business information and business insurance information associated with the merchant.

At block 504, the method 500 may include generating, by the one or more hardware processors 110, an identifier verification score and a business risk score for the received request based on a trained artificial intelligence risk model.

At block 506, the method 500 may include verifying, by the one or more hardware processors 110, the personal information, business information and business insurance information associated with the merchant based on the generated identifier verification score and the business risk score.

At block 508, the method 500 may include providing, by the one or more hardware processors 110, access to a real-time merchant portal based on results of verification and type of the merchant.

The method 500 may be implemented in any suitable hardware, software, firmware, or combination thereof. The order in which the method 500 is described is not intended to be construed as a limitation, and any number of the described method blocks may be combined or otherwise performed in any order to implement the method 500 or an alternate method. Additionally, individual blocks may be deleted from the method 500 without departing from the spirit and scope of the present disclosure described herein. Furthermore, the method 500 may be implemented in any suitable hardware, software, firmware, or a combination thereof, that exists in the related art or that is later developed. The method 500 describes, without limitation, the implementation of the system 102. A person of skill in the art will understand that method 500 may be modified appropriately for implementation in various manners without departing from the scope and spirit of the disclosure.

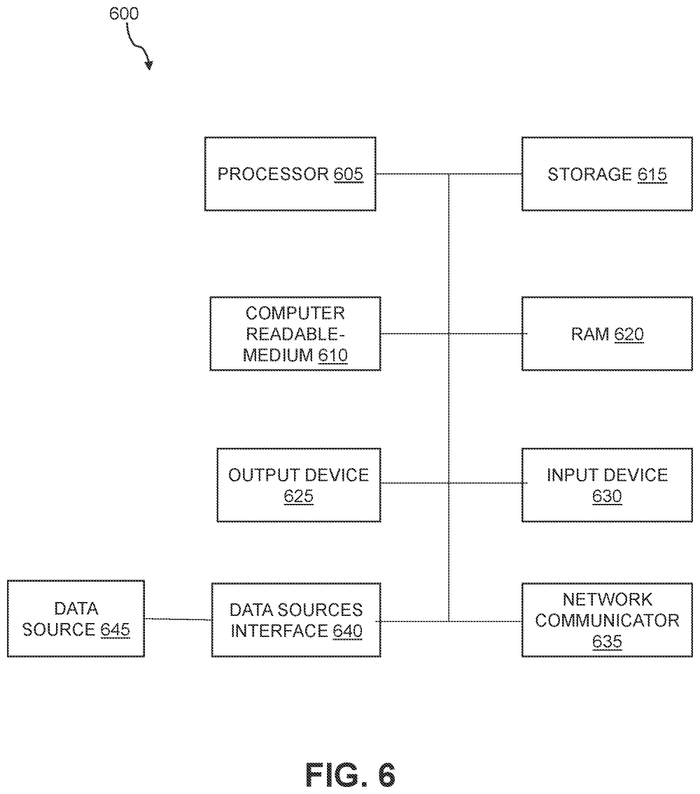

FIG. 6 illustrates an exemplary block diagram representation of a hardware platform 600 for implementation of the disclosed system 102, according to an example embodiment of the present disclosure. For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform 600. As illustrated, the hardware platform 600 may include additional components not shown, and some of the components described may be removed and/or modified. For example, a computer system with multiple GPUs may be located on external-cloud platforms including Amazon Web Services, internal corporate cloud computing clusters, or organizational computing resources.

The hardware platform 600 may be a computer system such as the system 102 that may be used with the embodiments described herein. The computer system may represent a computational platform that includes components that may be in a server or another computer system. The computer system may be executed by the processor 605 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 605 that executes software instructions or code stored on a non-transitory computer-readable storage medium 610 to perform methods of the present disclosure. The software code includes, for example, instructions to gather data and analyze the data. For example, the plurality of modules 114 includes a request handler 206, an artificial intelligence-based risk assessment module 208, and a merchant onboarding 210.

The instructions on the computer-readable storage medium 610 are read and stored the instructions in storage 615 or random-access memory (RAM). The storage 615 may provide a space for keeping static data where at least some instructions could be stored for later execution. The stored instructions may be further compiled to generate other representations of the instructions and dynamically stored in the RAM such as RAM 620. The processor 605 may read instructions from the RAM 620 and perform actions as instructed.

The computer system may further include the output device 625 to provide at least some of the results of the execution as output including, but not limited to, visual information to users, such as external agents. The output device 625 may include a display on computing devices and virtual reality glasses. For example, the display may be a mobile phone screen or a laptop screen. GUIs and/or text may be presented as an output on the display screen. The computer system may further include an input device 630 to provide a user or another device with mechanisms for entering data and/or otherwise interacting with the computer system. The input device 630 may include, for example, a keyboard, a keypad, a mouse, or a touchscreen. Each of these output devices 625 and input device 630 may be joined by one or more additional peripherals. For example, the output device 625 may be used to display the results such as bot responses by the executable chatbot.

A network communicator 635 may be provided to connect the computer system to a network and in turn to other devices connected to the network including other clients, servers, data stores, and interfaces, for example. A network communicator 635 may include, for example, a network adapter such as a LAN adapter or a wireless adapter. The computer system may include a data sources interface 640 to access the data source 645. The data source 645 may be an information resource. As an example, a database of exceptions and rules may be provided as the data source 645. Moreover, knowledge repositories and curated data may be other examples of the data source 645.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having.” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A computer-implemented system for onboarding a merchant on a computing platform, the computer-implemented system comprising:
one or more hardware processors;
a memory coupled to the one or more hardware processors, wherein the memory comprises a plurality of modules in form of programmable instructions executable by the one or more hardware processors, and wherein the plurality of modules comprises:
a request handler configured to receive a request for onboarding a merchant from a user, wherein the request comprises personal information, business information and business insurance information associated with the merchant;
an artificial intelligence-based risk assessment module configured to:
generate an identifier verification score and a business risk score for the received request based on a trained artificial intelligence risk model; and
verify the personal information, business information and business insurance information associated with the merchant based on the generated identifier verification score and the business risk score; and
a merchant onboarding module configured to provide access to a real-time merchant portal based on results of verification and type of the merchant.

2. The computer-implemented system of claim 1, wherein in receiving the request for onboarding the merchant from the user, the request handler is configured to:
receive personal information associated with the merchant from a user device;
authenticate the received personal information associated with the merchant based on corresponding information stored in one or more external sources; and
authenticate the user device based on device identifier.

3. The computer-implemented system of claim 1, wherein in receiving the request for onboarding the merchant from the user, the request handler is configured to:
obtain business information and business insurance information associated with the merchant from a user device, wherein the business information and business insurance information comprises legal business name, doing business as (DBA), business type, majority owner's name, business address, business phone, business cell, business email address, website, employer Identification number (EIN) number, business license, national provider identifier (NPI) number, business liability insurance information, years in business, number of employees, principals and executives, and annual sales volume.

4. The computer-implemented system of claim 1, wherein in generating the identifier verification score and the business risk score for the received request based on the trained artificial intelligence risk model, the artificial intelligence-based risk assessment module is configured to:
obtain credit information associated with the merchant;
verify the obtained credit information associated with the merchant; and
generate the business risk score for the received request based on the verified credit information.

5. The computer-implemented system of claim 1, wherein in generating the identifier verification score and the business risk score for the received request based on the trained artificial intelligence risk model, the artificial intelligence-based risk assessment module is configured to:
extract a set of parameters from the personal information, business information and business insurance information associated with the merchant;
classify the extracted set of parameters into one or more categories based on type of information;
apply the classified set of parameters to the trained artificial intelligence risk model; and
generate the identifier verification score and the business risk score for the received request based on results of the trained artificial intelligence risk model.

6. The computer-implemented system of claim 1, wherein in generating the identifier verification score and the business risk score for the received request based on the trained artificial intelligence risk model, the artificial intelligence-based risk assessment module is configured to:
obtain social media information, financial partner information, and services offered information associated with the merchant;
generate a social media score, business quality score for the merchant based on the obtained social media information, financial partner information, and services offered information; and
generate the business risk score based on the generated social media score, and the business quality score.

7. The computer-implemented system of claim 1, wherein in verifying the personal information, business information and business insurance information associated with the merchant based on the generated identifier verification score and the business risk score, the artificial intelligence-based risk assessment module is configured to:
obtain a valid government photo ID and biometric data of the merchant from a user device;
perform a biometric verification and user identity verification of the merchant using the obtained valid government photo ID and the biometric data;
determine fraud and risk associated with the merchant based on the biometric verification and the user identity verification; and
verify the personal information associated with the merchant based on the determined fraud and risk associated with the merchant.

8. The computer-implemented system of claim 1, wherein the business insurance information comprises an insurance declaration page and a contract used to document a project.

9. The computer-implemented system of claim 1, wherein in providing access to the real-time merchant portal based on results of verification and type of the merchant, the merchant onboarding module is configured to:
identify type of merchant based on the results of verification;
retrieve one or more access privileges based on the identified type of merchant; and
provide access to the real-time merchant portal based on the retrieved one or more access privileges.

10. A computer-implemented method for onboarding a merchant on a computing platform, the computer-implemented method comprising:
receiving, by one or more hardware processors, a request for onboarding a merchant from a user, wherein the request comprises personal information, business information and business insurance information associated with the merchant;
generating, by the one or more hardware processors, an identifier verification score and a business risk score for the received request based on a trained artificial intelligence risk model;
verifying, by the one or more hardware processors, the personal information, business information and business insurance information associated with the merchant based on the generated identifier verification score and the business risk score; and
providing, by the one or more hardware processors, access to a real-time merchant portal based on results of verification and type of the merchant.

11. The computer-implemented method of claim 10, wherein receiving the request for onboarding the merchant from the user comprises:
receiving, by the one or more hardware processors, personal information associated with the merchant from a user device;
authenticating, by the one or more hardware processors, the received personal information associated with the merchant based on corresponding information stored in one or more external sources; and
authenticating, by the one or more hardware processors, the user device based on device identifier.

12. The computer-implemented method of claim 10, wherein receiving the request for onboarding the merchant from the user comprises:
obtaining, by the one or more hardware processors, business information and business insurance information associated with the merchant from a user device, wherein the business information and business insurance information comprises legal business name, doing business as (DBA), business type, majority owner's name, business address, business phone, business cell, business email address, website, employer identification number (EIN) number, business license, national provider identifier (NPI) number, business liability insurance information, years in business, number of employees, principals and executives, and annual sales volume.

13. The computer-implemented method of claim 10, wherein generating the identifier verification score and the business risk score for the received request based on the trained artificial intelligence risk model comprises:
obtaining, by the one or more hardware processors, credit information associated with the merchant;
verifying, by the one or more hardware processors, the obtained credit information associated with the merchant; and
generating, by the one or more hardware processors, the business risk score for the received request based on the verified credit information.

14. The computer-implemented method of claim 10, wherein generating the identifier verification score and the business risk score for the received request based on the trained artificial intelligence risk model comprises:
extracting, by the one or more hardware processors, a set of parameters from the personal information, business information and business insurance information associated with the merchant;
classifying, by the one or more hardware processors, the extracted set of parameters into one or more categories based on type of information;
applying, by the one or more hardware processors, the classified set of parameters to the trained artificial intelligence risk model; and
generating, by the one or more hardware processors, the identifier verification score and the business risk score for the received request based on results of the trained artificial intelligence risk model.

15. The computer-implemented method of claim 10, wherein generating the identifier verification score and the business risk score for the received request based on the trained artificial intelligence risk model comprises:
obtaining, by the one or more hardware processors, social media information, financial partner information, and services offered information associated with the merchant;
generating, by the one or more hardware processors, a social media score, business quality score for the merchant based on the obtained social media information, financial partner information, and services offered information; and
generating, by the one or more hardware processors, the business risk score based on the generated social media score, and the business quality score.

16. The computer-implemented method of claim 10, wherein verifying the personal information, business information and business insurance information associated with the merchant based on the generated identifier verification score and the business risk score comprises:
obtaining, by the one or more hardware processors, a valid government photo ID and biometric data of the merchant from a user device;
performing, by the one or more hardware processors, a biometric verification and user identity verification of the merchant using the obtained valid government photo ID and the biometric data;
determining, by the one or more hardware processors, fraud and risk associated with the merchant based on the biometric verification and the user identity verification; and
verifying, by the one or more hardware processors, the personal information associated with the merchant based on the determined fraud and risk associated with the merchant.

17. The computer-implemented method of claim 10, wherein the receiving the request comprises the business insurance information comprises obtaining an insurance declaration page and a contract used to document a project.

18. The computer-implemented method of claim 10, wherein providing access to the real-time merchant portal based on results of verification and type of the merchant comprises:
identifying, by the one or more hardware processors, type of merchant based on the results of verification;
retrieving, by the one or more hardware processors, one or more access privileges based on the identified type of merchant; and
providing, by the one or more hardware processors, access to the real-time merchant portal based on the retrieved one or more access privileges.

19. A non-transitory computer-readable storage medium having instructions stored therein that, when executed by one or more hardware processors, cause the one or more hardware processors to:
receive a request for onboarding a merchant from a user, wherein the request comprises personal information, business information and business insurance information associated with the merchant;
generate an identifier verification score and a business risk score for the received request based on a trained artificial intelligence risk model;
verify the personal information, business information and business insurance information associated with the merchant based on the generated identifier verification score and the business risk score; and
provide access to a real-time merchant portal based on results of verification and type of the merchant.

20. The non-transitory computer-readable storage medium of claim 19, wherein in receiving the request for onboarding the merchant from the user, the one or more hardware processors is configured to:
obtain business information and business insurance information associated with the merchant from a user device, wherein the business information and business insurance information comprises legal business name, doing business as (DBA), business type, majority owner's name, business address, business phone, business cell, business email address, website, employer identification number (EIN) number, business license, national provider identifier (NPI) number, business liability insurance information, years in business, number of employees, principals and executives, and annual sales volume.
